(19) United States
(12) Patent Application Publication
(10) Pub. No.: US 2010/0156629 A1
(43) Pub. Date: Jun. 24, 2010

(54) MEMS DEVICES AND REMOTE SENSING SYSTEMS UTILIZING THE SAME

(75) Inventors: Daniel White Sexton, Niskayuna, NY (US); Glen Peter Koste, Niskayuna, NY (US); Aaron Jay Knobloch, Mechanicville, NY (US); Roderick Gordon Brown, Nottingham (GB); David William Vernooy, Niskayuna, NY (US)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, SCHENECTADY, NY (US)

(21) Appl. No.: 12/360,144

(22) Filed: Jan. 27, 2009

(30) Foreign Application Priority Data
Dec. 19, 2008 (GB) 0823088.0

(51) Int. Cl. G08B 21/00

(52) U.S. Cl. 340/540

(57) ABSTRACT

A remote sensing system comprises a micro-electromechanical sensor (MEMS) device comprising a sensing element, an exciting element to resonate the sensing element at resonant frequency from a remote location by transmitting signals comprising any of acoustic signals, optical signals, radio frequency signals, or magnetic induction signals, and a reader circuitry to read an original frequency of the sensing element from a remote location for determining a condition to which the MEMS device is exposed using signals comprising any of acoustic signals, optical signals, radio frequency signals, or magnetic induction signals.

### CROSS-REFERENCE TO RELATED APPLICATIONS

This application claims priority from co-owned, co-pending GB Application No. 0823088 filed on Dec. 19, 2008, which application is hereby incorporated by reference in its entirety.

### BACKGROUND

The invention relates generally to sensing systems and, more particularly, to a micro-electromechanical sensor (MEMS) device and a remote sensing system using the MEMS device.

One of the important applications of MEMS devices is in measuring ambient conditions such as pressure and temperature. Mechanical characteristics of sensing elements in MEMS devices change depending on the ambient conditions that they are trying to measure. This change in mechanical characteristics influences the mechanical resonance of the device and this effect is used to measure the ambient condition. One type of MEMS device for measuring ambient conditions includes a sensing element integrated with electronics. The sensing element is generally a mechanical structure, and the electronics both cause the sensing element to vibrate and are used to measure the element's vibrational frequency. The vibrational frequency of the sensing element is used to measure ambient conditions, as it can be made proportional to these conditions using mechanical stress transduction.

The electronics in such MEMS devices are co-located with the sensing element. The main drawback with such MEMS devices is that typically the operating conditions of the MEMS devices are restricted to the operating conditions of the electronics. The sensing element itself of MEMS devices can withstand broader ranges of temperature, pressure, or other harsh conditions, but the associated electronics pose limitations.

It would therefore be desirable to provide a MEMS device and a sensing system for remotely sensing temperature, pressure, or other measurands in harsh environments, eliminating the need for having electronics in close proximity to the sensor.

### BRIEF DESCRIPTION

In accordance with one embodiment disclosed herein, a remote sensing system comprises a micro-electromechanical sensor (MEMS) device consisting of a sensing element, an exciting element to resonate the sensing element at resonant frequency from a remote location by transmitting any of acoustic signals, optical signals, radio frequency signals, or magnetic induction signals, and a reader circuitry to read the frequency of the sensing element from a remote location for determining a condition to which the MEMS device is exposed, also using either acoustic signals, optical signals, radio frequency signals, or magnetic induction signals.

In accordance with another embodiment disclosed herein, a remote sensing method comprises resonating a sensing element of a micro-electromechanical sensor (MEMS) device at resonant frequency from a remote location by transmitting signals comprising any of acoustic signals, optical signals, radio frequency signals or magnetic induction signals and reading an original frequency of the sensing element from a remote location for determining a condition to which the MEMS device is exposed. A signal comprising any of acoustic signal, optical signal, radio frequency signal, or magnetic induction signal is emitted to interrogate the MEMS device. A signal reflected from the sensing element in response to the emitted signal is received and processed to obtain the frequency of the sensing element.

### DRAWINGS

These and other features, aspects, and advantages of the present invention will become better understood when the following detailed description is read with reference to the accompanying drawings in which like characters represent like parts throughout the drawings, wherein:

FIG. 1 illustrates an embodiment of MEMS device in accordance with aspects disclosed herein.

FIG. 2 illustrates another embodiment of MEMS device in accordance with aspects disclosed herein.

FIG. 3 illustrates another embodiment of the MEMS device in accordance with aspects disclosed herein.

FIG. 4 illustrates a block diagram of the remote sensing system in accordance with aspects disclosed herein.

FIG. 5 illustrates a system level block diagram of acoustic drive and induction read embodiment of the remote sensing system in accordance with aspects disclosed herein.

FIG. 6 illustrates a system level block diagram of induction drive and induction read embodiment of the remote sensing system in accordance with aspects disclosed herein.

FIG. 7 illustrates a system level block diagram of RF drive embodiment of the remote sensing system in accordance with aspects disclosed herein.

FIG. 8 illustrates a system level block diagram of an optical drive and optical read embodiment of the remote sensing system in accordance with aspects disclosed herein.

FIG. 9 illustrates a system level block diagram of another optical drive and optical read embodiment of the remote sensing system in accordance with aspects disclosed herein.

FIG. 10 illustrates a system level block diagram of an acoustic drive and acoustic read embodiment of the remote sensing system in accordance with aspects disclosed herein.

### DETAILED DESCRIPTION

Embodiments disclosed herein include micro-electromechanical sensor (MEMS) devices and remote sensing systems using MEMS devices. The sensing system is used to measure an ambient condition such as pressure or temperature to which the MEMS device is exposed. The MEMS device is placed at a location where information about ambient conditions is needed. The sensing system includes an exciting element to drive a sensing element of the MEMS device into resonance and a reader element to acquire the frequency of the sensing element to determine the ambient condition to which the MEMS device is exposed.

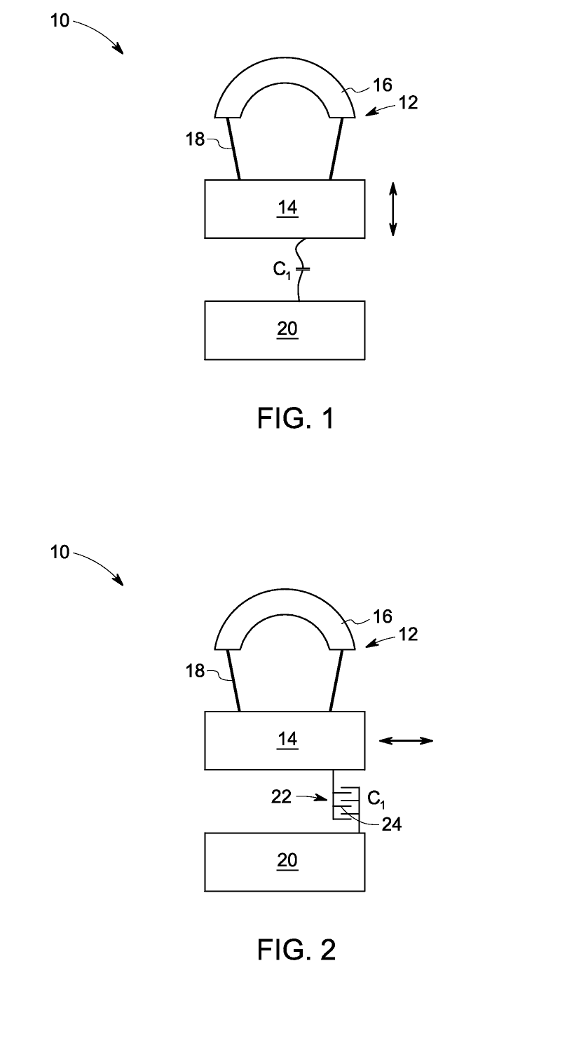

FIG. 1 shows a MEMS device 10. The MEMS device 10 is a passive sensor device, without any semi-conductor junctions or batteries, and does not include energy harvesting structures such as solar cells or acoustic scavengers that limit the operating temperature. The MEMS device 10 includes a sensing element 12 and may include a force capacitor C1. The sensing element 12 is a mechanical resonating sensing element with high Q (quality factor). In one embodiment, the sensing element 12 is a silicon-based mechanical resonator with Q greater than about 20,000 for accurate measurements. The sensing element 12 can be a micro-electromechanical mass-spring system with an inertial mass 14 coupled to a pressure-sensitive membrane 16 via a mechanism such as tethers 18 that act as springs. A forcing or driving capacitor C1 is formed between the inertial mass 14 and a fixed substrate 20. The inertial mass vibrates 14 up and down, as shown by arrows.

In another embodiment as shown in FIG. 2, the MEMS device 10 includes a sensing element 12 and may include an actuator 22, for example a comb-drive actuator. The sensing element 12 can be a micro-electromechanical mass-spring system that includes an inertial mass 14 and a pressure-sensitive membrane 16 coupled to the inertial mass 14 via a mechanism such as tethers 18 that act as springs. The actuator 22 may have a series of comb-like fingers 24 and is used as an electrical capacitor C1 to drive the sensing element 12. The electric force on the actuator 22 is approximately equal to the square of voltage across the actuator. This electric force can be used to induce movement in the actuator 22. The movement of the actuator 22 is translated to the inertial mass 14. In one embodiment, the inertial mass 14 vibrates laterally (i.e., side-to-side) at its resonant frequency.

Various means are used to energize the sensor remotely such as, but not limited to, thermal expansion using optical absorption, mechanical vibration using acoustic excitation, or electrically through induction, RF drive or direct drive of the force capacitor. A signal transmitting/receiving element can be used to drive the sensing element into resonance and/or read the frequency of the sensing element.

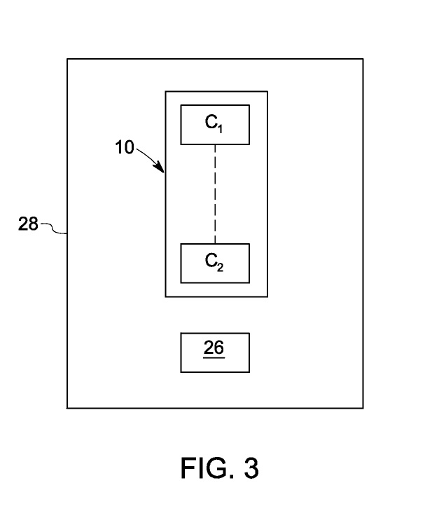

In the case of remote electrical actuation and readout, the MEMS device 10 may further include a sense capacitor C2 as shown in FIG. 3. A signal receiving/transmitting element 26 is associated with the MEMS device 10. The combination of the MEMS device 10 and the signal receiving/transmitting element 26 forms a sensor 28. The sense capacitor C2 may be physically connected to the force capacitor C1 and they may also share a common electrical connection. As will be explained in greater detail in relation to remote sensing system embodiments, the sensing element is vibrated at resonant frequency.

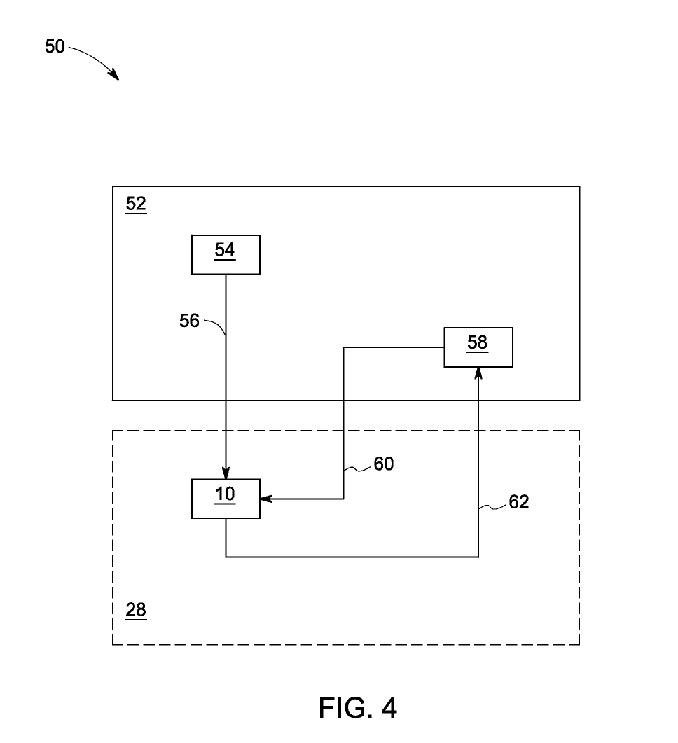

FIG. 4 illustrates a block diagram of the generic remote sensing system 50. The remote sensing system 50 includes the MEMS sensor device 10 and its associated interface, as well as a remote interrogator 52. The interrogator 52 can include an exciting element including a transmitter 54 to transmit a signal 56 for exciting the MEMS device 10 from a remote location. The transmitter 54 can include an ultrasonic transducer to transmit ultrasonic signals, a light source to transmit optical signals, or an electrical transmitter for radio frequency or magnetic induction signals to excite the MEMS sensing element. In the case of an optical approach, an optical fiber (not shown) might be used to transmit signals to the sensor and receive signals back from the sensor.

The interrogator 52 may further include reader circuitry 58, which transmits a signal 60 from a remote location to read the frequency of the sensing element of the MEMS device 10. The reader circuitry 58 can include an ultrasonic transducer to transmit ultrasonic signals, a light source to transmit optical signals, or an electrical transmitter for radio frequency or magnetic induction signals to interrogate the MEMS sensing element. In response to the transmitted signal 60, the MEMS device 10 sends a signal 62 back to the reader circuitry. The reflected signal 62 carries information about the frequency at which the sensing element is vibrating. The reflected signal 62 can be a signal that is directly re-radiated or reflected from the sensing element. In another embodiment, the reflected signal 62 is a signal generated by mixing frequencies of the transmitted signal and a motion-induced signal from the sensing element. The reader circuitry 58 analyzes the reflected signal 62 to acquire the frequency of the sensing element. The frequency of the sensing element is dependent upon ambient conditions such as pressure and temperature to which the sensing element is exposed.

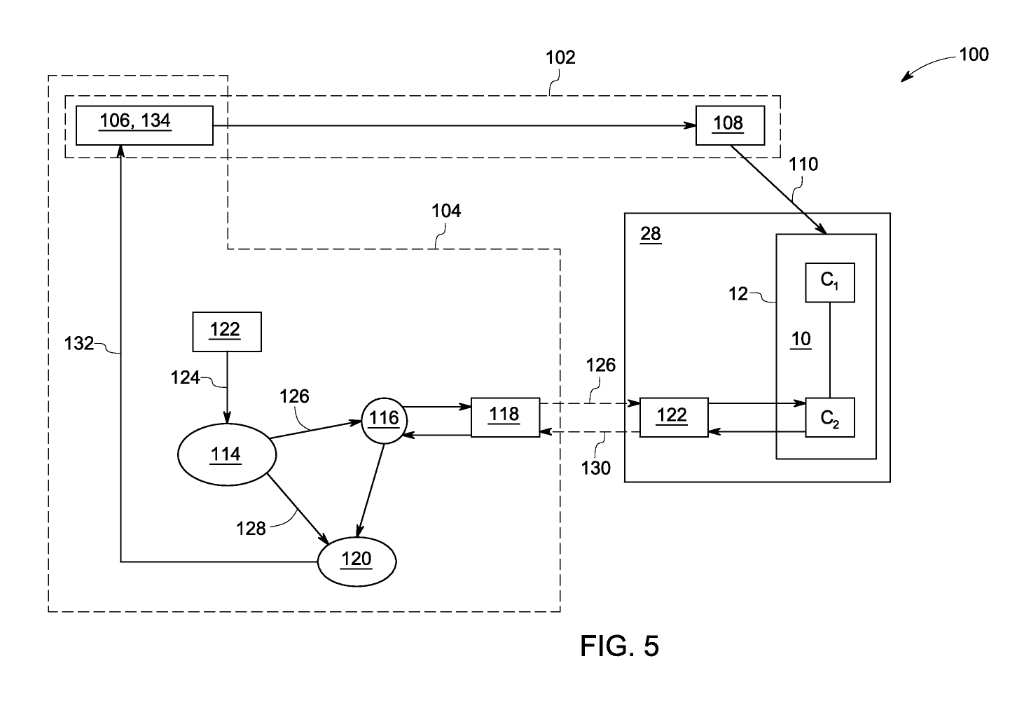

FIG. 5 illustrates a block diagram of an embodiment 100 of the remote sensing system where the exciting element 102 uses acoustic signals to resonate the sensing element and the reader circuitry 104 uses electromagnetic induction to interrogate the MEMS device 10. In this embodiment, the words “acoustic” and “ultrasonic” are used interchangeably, since the resonant frequency of the MEMS device is typically ˜20 kHz to 100 kHz and may be considered ultrasonic, although other resonant frequencies are possible.

The exciting element 102 can include a baseband oscillator 106 and an acoustic/ultrasonic transducer 108 such as a piezoelectric transducer. The baseband oscillator 106 may have a continuously variable frequency, as in a swept oscillator. An acoustic signal 110 is generated by an oscillator and transmitted to the MEMS device through the transducer. The acoustic signal 110 is at a baseband frequency f₀ that is close to the resonant frequency fᵣ of the sensing element 12. The frequency of the acoustic signal 108 is swept or caused to vary through the resonant frequency of the sensing element 12. As described previously, the sensing element 12 includes movable elements such as an inertial mass, a pressure sensitive membrane and spring tether connections. The acoustic signal 110 forms a pressure wave that vibrates movable elements to induce resonance in the inertial mass of the sensing element 12 when its frequency is coincident with the sensor's resonant frequency.

The reader circuitry 104 can be based, for example, on electromagnetic induction to interrogate the MEMS device. In this embodiment, several types of electromagnetic interrogation approaches can be used such as near field magnetic induction at frequencies less than about 100 MHz. The reader circuitry 104 includes a carrier signal generator/transmitter 112, a splitter 114, a circulator 116, a transmit/receive coil 118, and a mixer 120. The MEMS device 10 in this embodiment includes an inductive coil 122 as a signal transmitting/receiving element. The transmitter 112 transmits an un-modulated signal 124 at a frequency f₂. The splitter 114 receives the signal f₂ and splits into two separate signals, namely a first signal 126 and a second signal 128. The first signal 126 is transmitted to the transmit/receive coil through the circulator 116. The transmit/receive coil 118 transmits the first signal 126 to the inductive coil 122. The inductive coil 122 wirelessly acquires the signal 126 from the transmit/receive coil via magnetic induction. The second signal 128 will act as a reference signal at the receiver 134. In particular, it is used as a local oscillator in the mixer 120.

Because the sense capacitor C2 is physically attached to the inertial mass of the sensing element, the sense capacitor resonates when the sensing element 12 is forced into resonance by the acoustic drive signal 110. The sense capacitor C2 can be used as a frequency-mixing element using the principle that the electric force on the sense capacitor is approximately equal to square of the voltage. The first signal 126 from the reader circuitry at a frequency f₂ is enhanced by the Q of the electrical receiving circuit and mixes with the output frequency of the sensing element 12 to provide a modulated output signal 130 at f₂+/−f₀. The value of these modulated signals are largest when the swept frequency f₀ coincides with the mechanical resonance frequency fᵣ.

The transmit/receive coil 118 receives the re-radiated output signal 130 from the sensor 28, which now contains components at f₂+/−f₀ as mentioned above. The output signal 130 is then transmitted via the circulator 116 to the RF input of the mixer 120. The second signal 128 from the splitter 114 is provided to the local oscillator port as previously mentioned and an output signal 132 is taken from IF port of mixer 120. This signal 132 may then be analyzed at receiver 134 to determine the original frequency of the sensing element, for example, by looking for amplitude maxima or phase shifts as the baseband frequency f₀ is swept through the sensor's resonance fᵣ. The receiver 132 and swept oscillator source 106 can be integrated into a single unit. This functionality is similar to that found in a standard electronic network analyzer, although low cost implementations may be done with dedicated signal processors. The frequency determined at the receiver is used to determine an ambient condition to which the MEMS device is exposed.

There are many other interrogator embodiments or architectures that may be used. In one method, direct digitization of the received signal and the use of digital signal processing can be used determine the sensor resonant frequency. In another method, a “comb” of frequencies can be used to excite the resonator simultaneously, instead of using a swept frequency source. In another method, adaptive algorithms can be used to “search” for the resonant frequency based on the response of the sensor to a given excitation frequency. Furthermore, the time response “ringdown” of the resonator may be analyzed to determine the resonant frequency, as opposed to its frequency response.

In yet another system embodiment (not shown), the swept baseband oscillator 106 can be eliminated altogether. By applying appropriate gain and phase shifts to the output (IF) signal 132 from the mixer and feeding the resultant signal back to drive the acoustic/ultrasonic transducer 108, the entire system can be made into an oscillator. In this case, there is no need to “search” for the resonant frequency. The high Q nature of the system means that oscillations will only occur at the sensor's resonant frequency. It also guarantees that the system can oscillate on its own, building up only from noise. In this embodiment, the signal can be picked off anywhere and sent to a low cost electronic counting system to determine the frequency of the sensing element. This frequency is then used to determine an ambient condition to which the MEMS device is exposed.

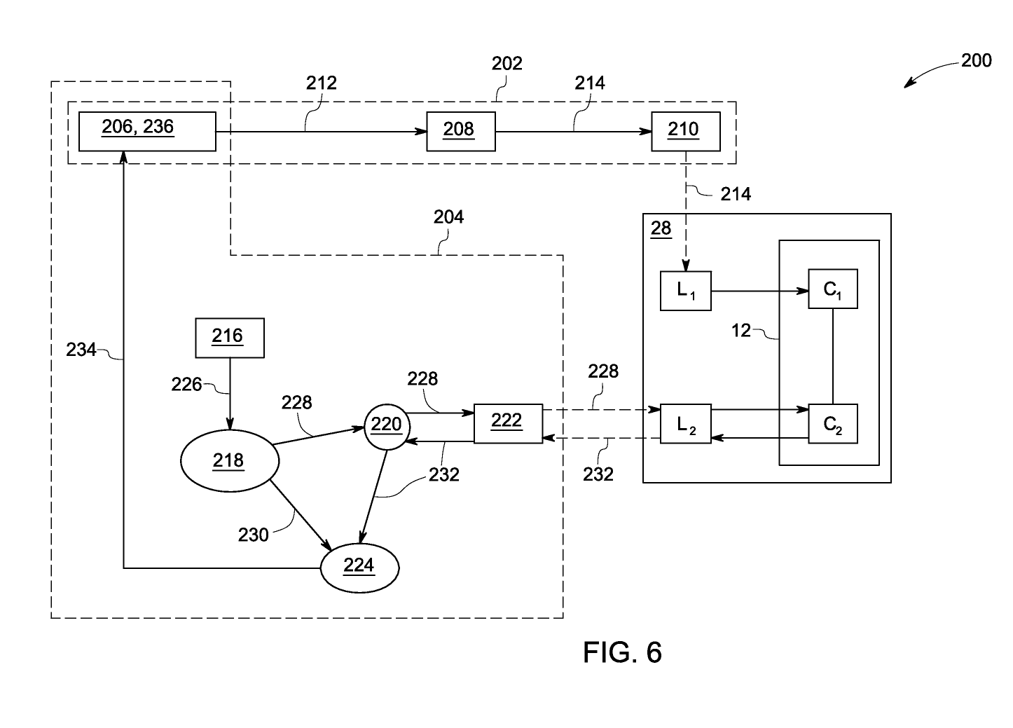

FIG. 6 illustrates an embodiment of the remote sensing system 200 where both exciting element 202 and reader circuitry 204 are based on electromagnetic induction. Several types of electromagnetic interrogation approaches can be used such as near field magnetic induction at frequencies less than about 100 MHz or high frequency RF/microwave electromagnetic excitation at frequencies greater than about 100 MHz. The exciting element 202 in this embodiment employs near field magnetic induction at frequencies less than about 100 MHz. The exciting element 202 includes a baseband oscillator 206, a carrier signal generator/transmitter 208, and a driving coil 210. The baseband oscillator generates a signal 212 at frequency f₀, and this frequency may be swept around the resonant frequency of the sensing element of the MEMS device. The carrier signal generator/transmitter 208 generates a signal at a frequency fₜ, which is modulated by the baseband signal at f₀ to produce signals 214 having new frequencies that are the sum and difference of the frequencies f₀ and f₁. The sensor 28 in this embodiment includes a first inductive coil L1 as a signal-receiving element. The driving coil 210 wirelessly transmits modulated signal 214 to the first inductive coil L1. As an example, f₀ is a swept oscillator at ˜30 kHz and f1˜10 MHz, but other combinations are possible.

The first inductive coil L1 is connected to the force capacitor C1, which acts as the sensor actuator. This forms a high Q electrical LC “tank” resonance circuit, maximizing the voltage across the actuator and, therefore, the electric force. Electrical Q values >10 are possible with this circuit. The electric force is used to mix-down the modulated electromagnetic drive signal directly at the MEMS device to produce a baseband signal f₀ to drive the actuator. When the swept frequency f₀ coincides with the mechanical resonance frequency, the sensing element is brought into resonance. In some embodiments, the sensor structure can include means of optimizing inductive power transfer between the drive and sensor coils, such as the use of ferrite materials. In other embodiments, low loss coil structures and fabrication techniques are used to optimize the electrical Q.

The reader circuitry includes 204 a second carrier signal generator/transmitter 216, a splitter 218, a circulator 220, a second transmit/receive coil 222, and a mixer 224. This circuit is identical to that described earlier in the acoustic/inductive approach. The MEMS sensor further includes a second inductive coil L2 as another signal transmitting/receiving element. The transmitter 216 transmits an un-modulated signal 226 at a frequency f₂. In one embodiment, the exciting element and the reader circuitry use different carrier frequencies. For example, the exciting element may use f₁˜10 MHz and the reader circuitry may use f₂˜15 MHz. Having two different frequencies enables the first and second inductive coils of the MEMS device to be of different sizes and can facilitate device layout.

The splitter 218 receives the signal at frequency f₂ and splits it into two separate signals, namely a first signal 228 and a second signal 230. The first signal 228 is transmitted to the transmit/receive coil 222 through the circulator 220. The transmit/receive coil 222 transmits the first signal 228 to a second inductive coil L2 at the sensor 28. The inductive coil L2 wirelessly acquires the signal 228 from the transmit/receive coil 222 via magnetic induction. The second signal 230 will act as a reference signal at the receiver. In particular, it is used as a local oscillator in the mixer 224.

Because the sense capacitor C2 is also physically attached to the inertial mass of the sensing element, the sense capacitor resonates when the sensing element is forced into resonance by the drive signal created at the first tank circuit that includes L1 and C1. The first signal 228 at a frequency f₂ is enhanced by the Q of the electrical receiving circuit including L2 and C2 and mixes with the output frequency of the sensing element at f₂+/−f₀ to provide a modulated output signal 232 at f₂+/−f₀. The sense capacitor C2 is used also as a frequency-mixing element using the principle that the electric force on the sense capacitor is approximately equal to square of the voltage. The value of these modulated signals 232 are largest when the swept frequency f₀ coincides with the mechanical resonance frequency fᵣ.

The transmit/receive coil 222 receives the re-radiated output signal 232 from the sensor tank circuit L2 and C2 and now contains components at f₂+/−f₀ as mentioned above. The output signal 232 is then transmitted via the circulator 220 to the RF input of the mixer 224. The second signal 230 from the splitter 218 is provided to the local oscillator port as previously mentioned and an output signal 234 is taken from the IF port of the mixer 224. This signal 234 may then be analyzed at receiver 236 to determine the original frequency of the sensing element, for example, by looking for amplitude maxima or phase shifts as the baseband frequency f₀ is swept through the sensor's resonance at fᵣ. The receiver 236 and swept oscillator source 206 can be integrated into a single unit. This functionality is similar to that found in a standard electronic network analyzer, although low cost implementations may be done with dedicated signal processors. The frequency determined at the receiver is used to determine an ambient condition to which the MEMS device is exposed.

Even in this embodiment, many other interrogator architectures may be used. In one method, direct digitization of the received signal and the use of digital signal processing can be used determine the sensor resonant frequency. In another method, a “comb” of frequencies can be used to excite the resonator simultaneously, instead of using a swept frequency source. In another method, adaptive algorithms can be used to “search” for the resonant frequency based on the response of the sensor to a given excitation frequency. Furthermore, the time response “ringdown” of the resonator may be analyzed to determine the resonant frequency, as opposed to its frequency response. In yet another method, two un-modulated carrier signals can be sent to the sensor, and their frequencies set such that the difference is close to the mechanical resonant frequency of the sensor. This down-conversion can take place in a high Q tank circuit at the sensor. The resultant motion of the sensor will cause new sidebands on the carriers, which can be detected back at the interrogator.

In another system-level implementation (not shown), the swept baseband oscillator 206 can be eliminated altogether. By applying appropriate gain and phase shifts to the output (IF) signal from the mixer and feeding the resultant signal back to the modulation of the first carrier frequency at fₜ, the entire system can be made into an oscillator. In this case, there is no need to “search” for the resonant frequency. The high Q nature of the system means that oscillations will only occur at the sensor's resonant frequency. It also guarantees that the system can oscillate on its own, building up only from noise. In this embodiment, the signal can be picked off anywhere and sent to a low cost electronic counting system to determine the frequency of the sensing element. This frequency is then used to determine an ambient condition to which the MEMS device is exposed.

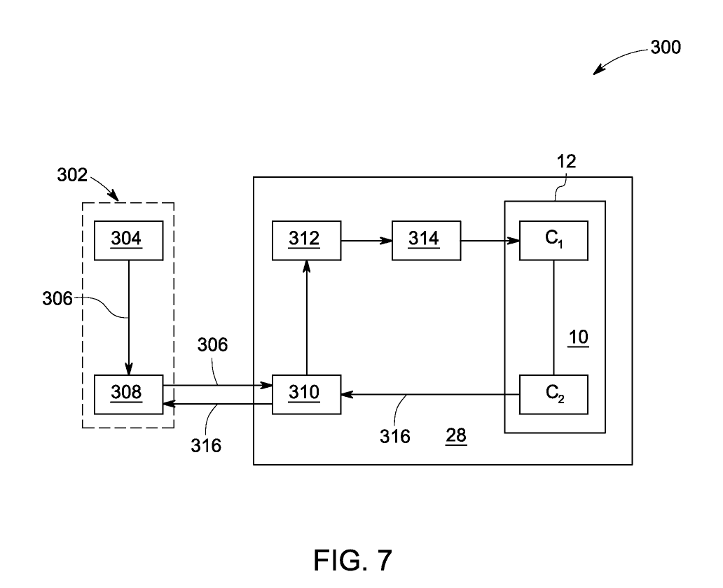

In another embodiment 300 as shown in FIG. 7, the exciting element employs high frequency RF/microwave electromagnetic excitation at frequencies greater than about 100 MHz to excite the sensing element 12 of the MEMS device. The exciting element in this embodiment includes an RF source 304 at f₁, modulated at the baseband frequency f₀, to generate a modulated signal 306 and an antenna 308 to transmit the modulated signal 306 to the sensor 28.

There are two possible ways to drive the MEMS sensor with this modulated RF signal 306. In the first approach, “direct” drive of the device is performed, requiring a receiving antenna 310 at the sensor 28 and impedance matching circuitry 312 to efficiently deliver the received power to the MEMS device 10. The modulated power is mixed by the square-law force-voltage relationship of the device capacitance to provide the baseband driving signal.

In a second approach, the MEMS device 10 includes an antenna 310 to receive the signal centered at f₁, impedance matching circuitry 312 to deliver this power to a non-linear element, and a non-linear element such as a Schottky diode 314 to mix-down the modulated signal to create the baseband signal at f₀. The baseband signal is then delivered to the actuator element to drive the sensing element 12 into resonance.

RF readout can be performed by interrogating the moving sensor with a second un-modulated signal at a frequency f₂. This frequency can be selected to be close to, but not overlapping with, the first RF carrier frequency f₁ such that it is within the bandwidth of the driving and receiving antennas. In this way, the antennas 308 and 310 at the interrogator and device may be used for driving and receiving. The moving sensor will modulate the back reflection or backscatter of the second frequency f₂, creating signals 316 at f₂+/−f₀. This modulated backscatter can be detected using synchronous detection at the interrogator 302 using a copy of the second signal at f₂ as a local oscillator.

Many other RF implementations can be considered, and some of these are covered in GB Application No. 0823088 filed on Dec. 19, 2008, which application is hereby incorporated by reference in its entirety.

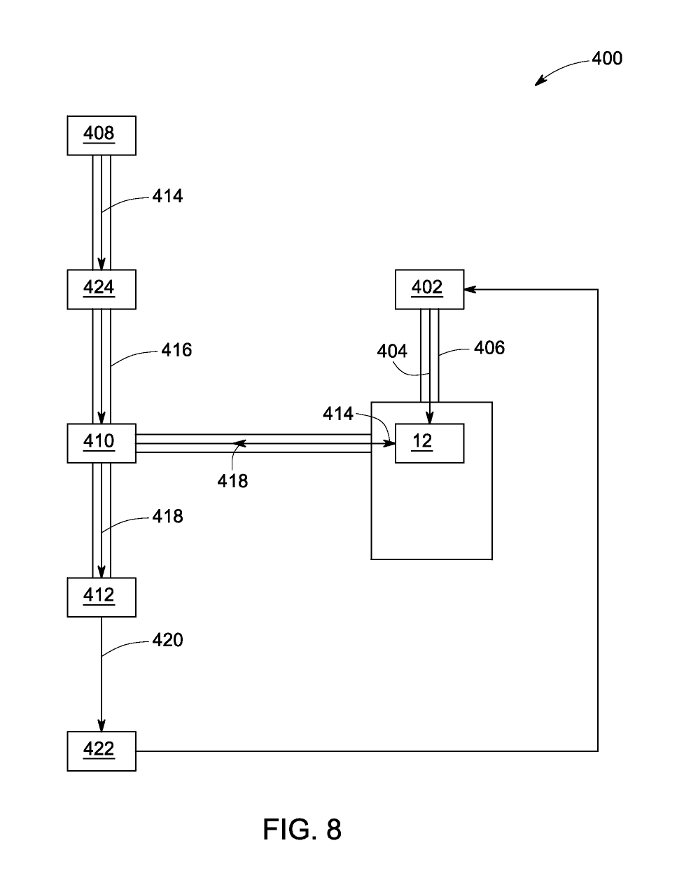

FIG. 8 illustrates an embodiment of the remote sensing system 400 where the exciting element uses a first optical signal such as an infrared light signal to resonate the sensing element and the reader circuitry uses a second optical signal to determine the frequency of the MEMS device. The exciting element includes a first optical source 402 such as, for example, an LED, laser, or super-luminescent LED to generate an optical signal 404. In one embodiment, an infrared signal is used for the optical signal. Other optical signals of various wavelengths can also be used, such as visible wavelengths. In this embodiment, two separate optical fibers are used to drive and then readout sensor, which provides spatial discrimination. This allows the same optical wavelength to be used for both of these functions without the threat of crosstalk or interference.

The exciting optical signal 404 is transmitted to the MEMS device 10 via a first optical fiber 406 that can be a single-mode fiber or a multimode fiber. This signal 404 can be modulated at a frequency f₀, which may be swept around the sensor resonant frequency. The actuation of the sensing element 12 is via absorption of the modulated optical signal 404. The MEMS device 10 may include means for optimizing the absorption such as, but not limited to, direct material absorption, doped material layers to enhance the absorption or thin metal absorbing layers. As discussed previously in reference to FIG. 1, the actuator can be the inertial mass of the sensing element 12. The absorption generates heat, which causes movement of the actuator via dynamic thermal expansion. If the modulation frequency f₀ coincides with the mechanical resonant frequency fᵣ, this induces resonance in the sensing element 12.

The reader circuitry includes a second optical source 408, an optical splitter 410, and a photodiode detector 412. The second optical source 408 can be an LED, laser, or super-luminescent LED to generate the reader optical signal 414. In this case, the reader optical signal 414 is not modulated. The reader optical signal 414 is transmitted to the MEMS device 10 through a second optical fiber 416, preferably a multimode optical fiber. The reader optical signal 414 enters the MEMS device 10 and reflects from the sensing element 12 that is being forced into resonance by the driving optical signal 404 from the exciting element. The reflected optical signal 418 passes back through the optical splitter 410 to the photodiode detector 412. The detected signal 420 is then analyzed at the receiver 422 to determine original frequency of the sensing element 12. The original frequency of the sensing element 12 is then related to mechanical resonance of the sensing element 12 to determine an ambient condition to which the MEMS device is exposed.

Several options can be included to enhance the system performance, including the use of optical isolators 424 to isolate the sources from back-reflections, optical filters and various combinations of single mode and multimode fiber. The receiver 422 can be integrated with a swept oscillator source that is used to drive the first optical source 402.

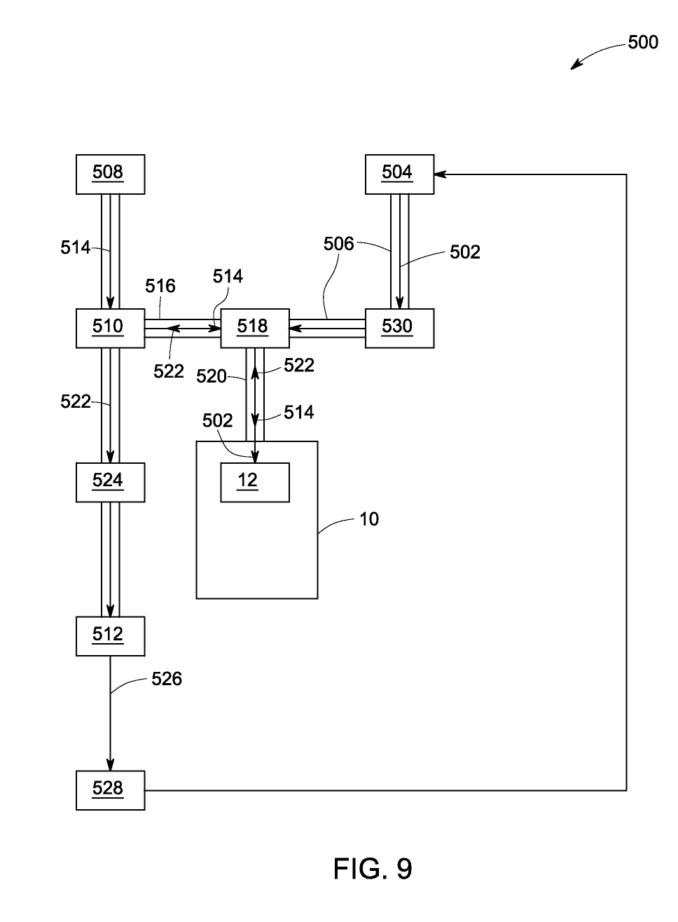

FIG. 9 illustrates another embodiment of the remote sensing system 500 using the optical approach, in which only a single fiber is used to interface to the MEMS device. In this case, two different source wavelengths for interrogation and readout are needed to ensure there is no crosstalk or interference.

A modulated driver optical signal 502 generated by a first optical source 504 is transmitted through a first optical fiber 506. The reader circuitry includes a second optical source 508, an optical splitter 510, and a photodiode detector 512. A reader optical signal 514 generated by the second optical source 508 is transmitted to the splitter 510 through a second optical fiber 516. The driver optical signal 502 on the first optical fiber 506 and the reader optical signal 514 at the output of the splitter 510 on a second optical fiber 516 are combined in a wavelength-division multiplexer 518 onto a common optical fiber 520 that is connected to the MEMS device 10. This last stretch of fiber 520 is most preferably multimode fiber.

The mechanisms for drive and readout are identical to that described previously, except that the reflected portion 522 of the read optical signal is separated from the reflected portion (not shown) of the drive optical signal in the wavelength-division multiplexer 518. This reflected signal 522 is sent back to the splitter 510 to a photodiode detector 512, where it is analyzed to determine the resonance frequency of the sensing element 12. The detected signal 526 is then analyzed at the receiver 528 to determine original frequency of the sensing element 12. The original frequency of the sensing element 12 is then related to mechanical resonance of the sensing element 12 to determine an ambient condition to which the MEMS device is exposed. In this case, the photodiode detector 512 further includes an optical bandpass filter 524 to ensure minimal contamination from the driving optical signal wavelength. Also, an optical isolator 530 can be used to isolate any sources from back-reflections.

In another system-level implementation, which can be used in either the two-fiber or one-fiber interrogation approaches, it is possible to eliminate the need to sweep the modulation to search for the sensor resonance frequency. In this case, the output of the detection photodiode is amplified, phase shifted and then directly fed back to the modulation input of the driving laser. With enough gain, the entire system will again oscillate, allowing auto-detection of the resonance frequency. This is similar to the mechanisms described previously, and here again the signal can be picked off anywhere in the loop and sent to low cost counting electronics to determine the resonance frequency.

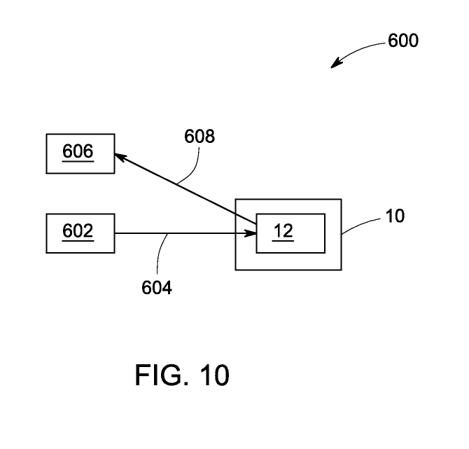

In another embodiment 600 shown in FIG. 10, both the exciting element and reader circuitry use ultrasonic signals. The exciting element 602 can include an ultrasonic transducer such as a piezoelectric speaker or tweeter to transmit acoustic signals 604. The frequency of the acoustic signal is swept to induce resonance in the sensing element 12 of the MEMS device 10. As described previously, the sensing element 12 includes movable elements such as an inertial mass, a pressure sensitive membrane and tether connections acting as springs. The acoustic signal 604 forms a pressure wave that vibrates movable elements to induce resonation in the inertial mass of the sensing element 12.

The reader circuitry 606 includes a second ultrasonic transducer acting as a microphone pickup to interrogate the MEMS device 10. The interrogating ultrasonic signals 608 are reflected from the sensing element 12 and the original frequency of the sensing element 12 is determined from these reflections 608. The MEMS device 10 in this embodiment does not need to have any electronic circuitry. The device 10 may include features to enhance the reflection and transmission of ultrasonic signals into and out of the sensor, include acoustic impedance matching layers and acoustic wave-guiding structures.

It should be noted that “driving” and “receiving” circuitry in each of the above embodiments can be mixed and matched for a particular application. For example, optical driving can be combined with RF reading, or acoustic drive could be combined with optical reading. Many other combinations are possible. This may be advantageous in certain situations where the environment favors one embodiment over another. Furthermore, each of these methods could be combined with either direct wired electrical drive or read to form a hybrid wireless/wired resonant sensor. This may be advantageous in cases where electrical isolation between drive and read circuitry is desired, for example, to reduce noise or crosstalk.

The remote sensing systems using the MEMS device described above thus provide a way to remotely excite the MEMS device and remotely acquire frequency of the sensing element to measure ambient conditions to which the sensing element is exposed. The MEMS device and the sensing system enable remote sensing of pressure, temperature or other measurands in harsh environments while eliminating the need for wiring, batteries, active electronics, and physical access to the sensor. Absence of active electronics makes the MEMS device suitable for high temperature and pressure applications. The remote sensing system has applications in harsh temperature, pressure, chemical, and noise environments.

It is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A remote sensing system, comprising:
a micro-electromechanical sensor (MEMS) device comprising a sensing element;
an exciting element to resonate the sensing element at resonant frequency from a remote location by transmitting signals comprising any of acoustic signals, optical signals, radio frequency signals, or magnetic induction signals; and
a reader circuitry to read an original frequency of the sensing element from a remote location for determining a condition to which the MEMS device is exposed using signals comprising any of acoustic signals, optical signals, radio frequency signals, or magnetic induction signals.

2. The system of claim 1, wherein the reader circuitry emits the signals to interrogate the MEMS device and receives and processes signals reflected from the MEMS device to acquire frequency of the sensing element.

3. The system of claim 2, wherein the signals reflected from the MEMS device comprise signals re-radiated from the sensing element or signals generated by mixing frequencies of the signals transmitted by the reader circuitry and a motion induced signal from the sensing element.

4. The system of claim 2, wherein the reader circuitry is configured to drive the exciting element.

5. The system of claim 4, wherein the system is made into an oscillator by applying gain and phase shifts to the reflected signals before analyzing the signals reflected from the MEMS device.

6. The system of claim 5, wherein oscillations are made to occur at resonant frequency of the sensing element, thereby eliminating the need for the signals transmitted by the exciting element to search for the resonant frequency of the sensing element.

7. The system of claim 2, wherein the signals transmitted by the reader circuitry and the signals transmitted by the exciting element can be of same or different frequencies.

8. The system of claim 1, wherein the sensing element comprises a mechanical resonating sensing element.

9. The system of claim 8, wherein the sensing element comprises a micro-electromechanical (MEMS) mass-spring system.

10. The system of claim 1, wherein the MEMS device further comprises a frequency mixing element and a signal transmitting/receiving element.

11. The system of claim 1, wherein the signals transmitted by the exciting element are swept or caused to vary for searching resonant frequency of the sensing element.

12. The system of claim 1, wherein the MEMS device further comprises at least one capacitor and/or an actuator.

13. The system of claim 1 further comprises signal-controlling elements such as a splitter, a mixer, a circulator, an isolator, or combinations thereof.

14. The system of claim 1, wherein the condition comprises pressure or temperature.

15. A remote sensing method, comprising:
resonating a sensing element of a micro-electromechanical sensor (MEMS) device at resonant frequency from a remote location by transmitting signals comprising any of acoustic signals, optical signals, radio frequency signal, or magnetic induction signals; and
reading an original frequency of the sensing element from a remote location for determining a condition to which the MEMS device is exposed, comprising:
emitting signal comprising any of acoustic signal, optical signal, radio frequency signal, or magnetic induction signal to interrogate the MEMS device; and
receiving a signal reflected from the sensing element in response to the emitted signal and processing the reflected signal to obtain the original frequency of the sensing element.

16. The method of claim 15 further comprises: generating the reflected signal by mixing frequencies of the signals emitted to read the original frequency of the sensing element and a motion induced signal from the sensing element.

17. The method of claim 15 further comprising: applying gain and phase shifts to the reflected signal before processing the reflected signal.

18. The method of claim 15, wherein the signals transmitted to resonate the sensing element and the signals emitted to read the original frequency of the sensing element can be of same or different frequencies.

19. The method of claim 15, wherein the sensing element comprises a mechanical resonating sensing element.

20. The system of claim 19, wherein the sensing element comprises a micro-electromechanical (MEMS) mass-spring system.

21. The method of claim 15, wherein the signals transmitted to resonate the sensing element are swept or caused to vary for searching resonant frequency of the sensing element.

22. The method of claim 15, wherein the MEMS device further comprises at least one capacitor and/or an actuator.

23. The method of claim 15 further comprising: controlling the signals using signal control elements comprising a splitter, a mixer, a circulator, an isolator, or combinations thereof.

24. The method of claim 15, wherein the condition comprises pressure or temperature.
